(19) United States
(12) Patent Application Publication
(10) Pub. No.: US 2021/0401087 A1
(43) Pub. Date: Dec. 30, 2021

(54) DOUBLE-PROTECTION MEDICAL MASK, PREFERABLY FOR FILTERING DUST, SMOG, AEROSOL, PATHOGENIC AGENTS, VIRUSES AND THE LIKE

(71) Applicant: GENT S.R.L., 57023 CECINA (LI) (IT)

(72) Inventors: DEBORA SIMEONE, MONTESCUDAIO (IT); ELENA VINCHESI, CECINA (IT); GAIA VINCHESI, CECINA (IT); LEONARDO VINCHESI, CECINA (IT); MASSIMO VINCHESI, CECINA (IT); TOMMASO VINCHESI, CECINA (IT)

(21) Appl. No.: 17/339,423

(22) Filed: Jun. 4, 2021

(30) Foreign Application Priority Data
Jun. 5, 2020 (IT) 102020000013420

(51) Int. Cl. A41D 13/11; A41D 31/102; A41D 31/30; A62B 23/02

(52) U.S. Cl. CPC A41D 13/1176; A41D 13/113; A62B 23/025; A41D 31/30; A41D 31/102

(57) ABSTRACT

Described is a double-protection medical mask (1, 101), preferably for filtering dust, smog, aerosol, pathogenic agents, viruses and the like, which comprises a portion (2, 102) covering at least of the area of the nose, mouth and chin, provided with filtration means and designed to be hermetically and removably fixed to the face of the user (9) by adhesion means.

This invention relates to a double-protection medical mask, preferably for filtering dust, smog, aerosol, pathogenic agents, viruses and the like.

According to the prior art, most medical masks on the market do not guarantee active and passive protection which satisfies the required standards, especially in the case of any subsequent re-use.

The term “passive protection” refers to that needed by a healthy individual to protect against infection.

The term “active protection” refers to that which must be applied to individuals who are able to infect others.

The filtering masks present on the market are in fact classified on the basis of the degree of protection which they can guarantee according to international technical specifications: these medical devices are designed to provide personal protection against both solid and liquid aerosols.

Normally, a filtering mask which must cover the zone of the nose, mouth and chin of the operator may be equipped with one or more breathing in and/or out valves and may be used for several working shifts if specific requirements are met, again according to current standards.

The masks present on the market can be divided into three categories: those equipped with two elastic means for gripping behind the ears, masks having one or more elastic means for gripping around the head and those with fabric ties that need to be tied around the head in various ways.

However, masks equipped with ties or elastic elements very often lend themselves to incorrect and dangerous use; due to habits and convenience, many operators often loosen one of the ties or slide the elastic elements around the neck, exposing the inner part of the mask to external contagion and thus adversely affecting its subsequent operation, so that the mask, once contaminated from the inside, instead of protecting, acts as a vehicle for infection and a real incubator of pathogens.

Without mentioning the extremely risky use of the mask by normal users who, after use, replace it on surfaces that are at risk of contamination, or even insert it into their pocket, then put it on again instead of throwing it away.

Moreover, irrespective of the fixing mechanism, all these masks, even the most protective ones (FFP3) in reality have more or less marked sealing problems mainly for the following reasons.

Firstly, the prior art masks have facial sealing problems: since each face is different, such masks do not adapt ergonomically to all the shapes of the face of all persons, that is to say, to the various morphological shapes of men (especially if they have beards), women and children.

Secondly, the masks depend on the working environment and the outside environment, that is to say, on the type of particles and dust.

Moreover, the prior art masks have problems of loss of seal of the valves as well as sealing losses due to filter penetration.

The aim of the invention is to overcome the above-mentioned drawbacks in prior art types of double-protection medical masks, preferably for filtering dust, smog, aerosol, pathogenic agents, viruses and the like which allows elimination of the problems of facial seal as well as the problems connected to the outside environment, thereby making a mask which guarantees the perfect seal for any facial morphology of the user and for any form of contagion from liquids, solids, fine dusts, pathogenic agents, viruses (including SARS and COVID, including COVID-19).

In the context of the above-mentioned purpose, an aim of the invention is to provide a double-protection medical mask, preferably for filtering dust, smog, aerosol, pathogenic agents, viruses and the like, which guarantees hygiene and safety for the user who temporarily removes it and then re-wears it.

Another aim of the invention is to provide a mask equipped with an active and passive double-protection system which has a greater effectiveness than the masks available on the market.

Another aim of the invention is to provide a mask which is impermeable to fluids, also to liquids and aerosols.

Another aim of the invention is to provide an active and passive double-protection mask equipped with a mechanism for adjusting the mask which can be instantaneously personalised by the user whilst maintaining the same safety features initially guaranteed.

Yet another aim of the invention is to provide a double-protection medical mask, preferably for filtering dust, smog, aerosol, pathogenic agents, viruses and the like, with means which are easily available on the market and using materials of common use, in such a way that the device is economically competitive.

This purpose, as well as these and other aims which will become clearer below, are achieved by a double-protection medical mask, preferably for filtering dust, smog, aerosol, pathogenic agents, viruses and the like, according to the invention, comprising the technical features described in one or more of the appended claims. The dependent claims correspond to possible different embodiments of the invention.

More specifically, according to a first aspect, the invention relates to a double-protection medical mask, preferably for protection against liquids, dust, smog, aerosols, pathogenic agents, viruses and the like, which comprises a covering portion equipped with filtering means (valves or made of filter material), also of the preformed shell type, which covers at least the zone of the nose, mouth and chin.

The covering portion is designed to be hermetically and removably fixed to the face of the user by adhesion means in such a way that no fluid, dust or pathogen can penetrate inside the zone protected by the covering portion itself. This technical feature therefore allows the user to wear the mask without problems, shaping the border perfectly to the surface of the face irrespective of its morphology.

Even in extreme situations, since the mask remains impermeable to the entrance of fluids, it allows the user to carry out short immersions in liquids and/or aerosols without incurring damage nor a reduction in efficiency.

Advantageously, the covering portion comprises bactericidal means—of known type—applied to its inner surface, that is to say, the one facing the face of the user, in such a way as to implement the medical safety of the device.

The Applicant has provided that, in order to help the user to better control a correct use of the device, there are means in the covering portion for controlling the regular use of the mask (duration of use and expiry date), which are applied to it.

These control means are preferably suitable substances, of known type, designed to vary their colour, over time, once in contact with the oxygen of the atmosphere thus allowing the user to check the period of use and, therefore, whether the mask needs to be replaced and/or washed.

To make the mask more easily shaped to the face, the covering portion has a double folded peripheral edge (with a pleating-like action). The double edge is inserted along at least a part of the perimeter edge of the covering portion, between the outer surface of the covering portion, that is to say, the one facing the outside environment relative to the chamber formed by the mask and the face of the user, and the adhesion means.

The Applicant has concluded that the adhesion means may consist in the provision of a layer of medical glue, of known type, along the perimeter edge of the covering portion, so as to allow the use of the mask even without the need for attachment means, such as ties or elastic elements, which attach it to the ears of the user.

Obviously, for any need, the mask may also be equipped with ties, preferably but not necessarily elastic, for certain conditions of use or re-use. This make does not create problems of use and remains attached to the face without creating discomfort or inconvenience of any kind.

In this context, the layer of medical glue is preferably breathable, so as to allow the underlying skin to breathe, and of the bactericidal type, to complete the protective action.

According to a variant embodiment of the double-protection medical mask, preferably for protection against liquids, dust, smog, aerosols, pathogenic agents, viruses and the like, the adhesive means comprise a gelled layer, that is to say, made of gel, rubber, hydrogel, silicone, etc., deposited along the inner perimeter edge of the covering portion. This gelled layer is advantageously designed to adhere to the face of the user and on itself so as to adapt to the shape of the face of the user.

The Applicant has perceived that, with this feature, extremely contagious viruses, such as COVID viruses, which propagate also by means of the flow of air coming from air conditioning systems that accelerate the normal speed of the air, cancelling out the various measures adopted (social distancing), are completely screened; all the current devices, in fact, are designed for “front” protection, and this results in the fact that the lateral openings of the masks, in the presence of flows coming from behind the user, unfortunately act as true and proper conveyors of impure air inside the mask.

With this type of mask, on the other hand, the hermetic closing of the nose-mouth-chin zone avoids any risk or danger of that kind, even in environments in which there is a forced air circulation system (hospitals, restaurants, cinema, etc.).

This feature of the invention allows the use of the mask in particular critical conditions of use, such as hospitals (intensive care, infectious diseases, active and passive contamination risk departments, common zones, lifts, dispensaries . . . ), on immunosuppressed persons, in testing laboratories, immunological and viral research laboratories, testing laboratories with a high risk of contamination, university research centres, war zones with a risk of chemical and/or bacteriological and/or viral attacks, zones at risk of industrial pollution, etc.

In order to allow the user to momentarily take off the mask and then safely put it back on, it is advantageously designed—thanks to the presence on the perimeter edge of the adhesive layer or other adhesion means, for example the mechanical closure—to be folded into at least two parts, a right-hand part and a left-hand part relative to a transversal axis of the covering portion, in such a way that, once the mask has been folded, the right-hand part is hermetically and removably associated with the left-hand part thanks to the sealing of the respective right perimeter edge on the left, so that the entire inner chamber of the mask, the one defined by the covering portion and by the face of the user, is protected against any possibility of external contagion, until the moment it is subsequently re-used. With this feature, the user can fold the mask on itself, adhering to each other the perimeter adhesion edges (right and left), and then place it, for example, in the pocket of the gown, ready to be re-used when necessary in absolute safety, without ever being subjected to any contagion, without the risk of loss of safety, seal and functionality of the medical device.

The term “transversal axis” means the axis of symmetry which corresponds to the vertical nose-chin direction when the mask is worn by the user.

According to an alternative or complementary solution, the adhesion edges adhere to each other by means of a hermetic closing system similar to the male/female mechanism for closing plastic bags designed for food storage, or sealed hinges.

According to a particular version of the invention, the mask is made of water-repellent fabric which is able to make it impermeable to liquids, even in the form of aerosols.

According to a particular version of the invention, the mask is made of fabric which can be washed for use and re-use many times. In this case, the edge will be made of a suitable adherent material, which does not lose its adhesion characteristics after washing.

The perimeter edge designed to be adherent to the face, by gluing or with other means, suitably shaped and folded, therefore represents an effective system able to make the mask hermetic to any contact with dust and liquids, reaching an absolute degree of protection, maintaining efficiency and insulation (sealed to 100%), preserving the health of the user in all conditions of use.

Moreover, this perimeter edge seals the mask allowing the inner part of the covering portion to remain always clean and uncontaminated, before use, during use, during its re-use and at the end of its use: during all these steps of use the adhesion means and/or the mechanical closing mechanism protect the inner part of the mask, that is, the part which is in direct contact with external contagion, both from dust and liquids.

Preferably, in order to protect the inner chamber formed by the mask and by the face of the user, the Applicant has provided that, in addition to the adhesion means, whether they are adhesives, hydrogel or silicone, the perimeter edge may have preservation means which are impermeable to water and air, such as, for example, a watertight micro-hinge or a hermetic closing mechanism made of plastic, of the type used in bags with male-female edges, or a mechanical closing system with Velcro, or with a suction effect or even a magnetic system.

Preferably, the mask is equipped with one or more valves for breathing in and/or out.

Similarly, the fabric for making the mask will also have water-repellent properties and will therefore be able to make itself impermeable to water, which is not absorbed by the fabric.

Advantageously, the invention therefore comprises a double-protection system: a first protection guaranteed by the presence along the inner perimeter margin of the perimeter adhesion edge on the face of the user, in a sealed fashion, and a second protection guaranteed by the adhesion means provided on the inner perimeter margin and/or by the preservation means (gelled layer, watertight micro-hinge, plastic hermetic closing mechanism of the type used in bags with male-female flaps, mechanical closing system with Velcro, suction effect or magnetic means) for the closing and protection.

This double protection system makes it possible to guarantee without distinction all the users, whether they are healthy or infected.

Advantageously, the mask has a two-dimensional bar code comprising at least one cryptogram for storing information (the so-called “QR Code”) generally designed to be read by optical means connected to a processing unit (for example by a smartphone), in such a way as to be able to access a data processing program, that is to say which allows, by downloading a dedicated application on the relative device, information to be provided on the methods and time of use of the mask, the place of use, the quantity available for each operator, and to place orders for supplies when they fall below minimum threshold, etc.

According to a particular version of the invention, the mask is of the preformed “shell” type, but still has the central border, the adhesion means and the closing system.

According to an additional embodiment, the covering portion not only covers the wearer's nose, mouth and chin, but the entire face including the eyes which will be protected by special visors made of optically transparent material, integrated in the body of the mask.

In this case, too, the mask will have one or more of the technical features mentioned above.

This integral protection system is very effective for protecting all personnel working in research centres, hospitals and professional laboratories, which are subject to considerable risks of serious contamination.

Thanks to the fact that the perimeter edge makes the profile of the mask adheres to the face perfectly, the mask does not need any metal wire above the nose (which, however, can obviously be provided).

In any case, the mask of this kind protects the user with a double protection system and allows both the active and passive protection to be performed simultaneously and synergically, during all the steps of use, from opening, to use, to re-use, up to final disposal, which is also guaranteed under conditions of maximum safety.

The expression “double-protection” means a first protection wherein the adhesion edge, suitably shaped and folded, renders the mask hermetic for any contact with dust and liquids, reaching an absolute degree of protection, which is accompanied by a second protection whereby the adhesion edge (or, similarly, mechanical closing systems such as hinges, male/female closure, Velcro or magnetic) completely seals the mask, allowing its inner part to remain always clean and uncontaminated (prior to use, during use, during its re-use and at the end of its use). During all these steps of use the adhesion means protect the inner part of the mask, that is to say, the part in direct contact with the user, from any external contagion, both from dust and liquids.

This double protection system therefore guarantees the safety of all users: both the healthy individuals and those infected.

In this way, in fact, a user who has not already been infected will always be protected during the entire cycle of use of the mask: when it is used, when it is set aside, when it is re-used and when it is disposed of. During all these steps, the adhesive (or the mechanical closure) allows maximum protection both when the mask is worn and when it is momentarily set aside, when it is re-used, and when it is disposed of.

On the other hand, a user who has already been infected, when using this new invention will be completely isolated from the outside environment and will no longer be subject to possible contamination from persons who come into contact with him/her.

Once the mask has been used, the latter can be closed on itself by causing the adhesive flaps to adhere to each other, definitively sealing all the pathogenic agents inside it and it can be disposed of in complete safety.

Further features and advantages of the invention are more apparent in the detailed description below, with reference to a preferred, non-limiting embodiment of the double-protection medical mask, preferably for filtering dust, smog, aerosol, pathogenic agents, viruses and the like, illustrated by way of example and without limiting the scope of the invention, with the aid of the accompanying drawings, in which:

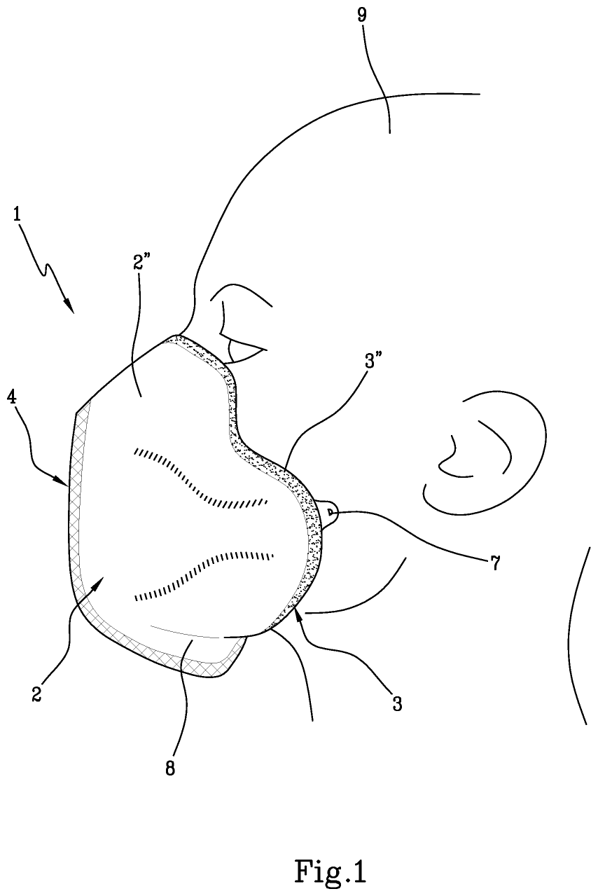

FIG. 1 shows a side view of a user 9 wearing an embodiment of the mask 1;

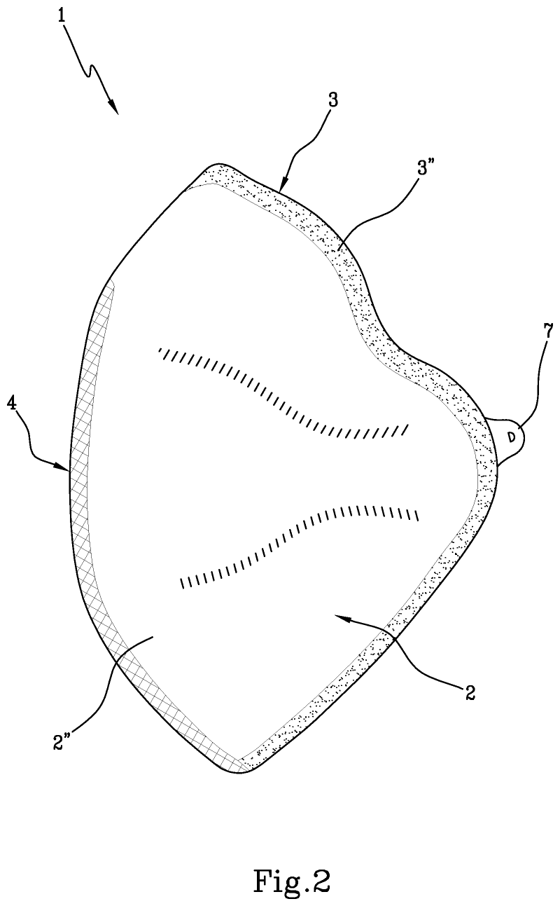

FIG. 2 shows the mask 1 folded back on itself;

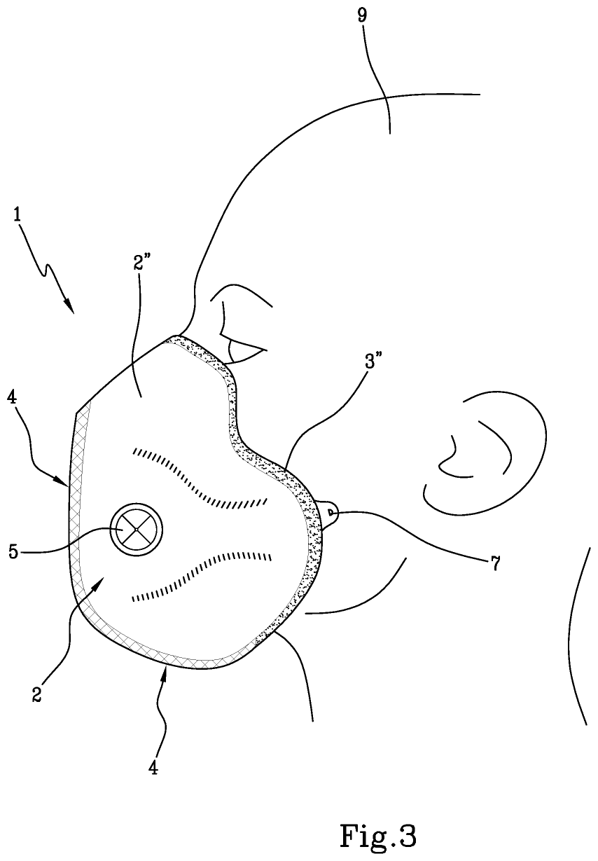

FIG. 3 shows a side view of a user 9 wearing another embodiment of the mask 1, equipped with a valve 5;

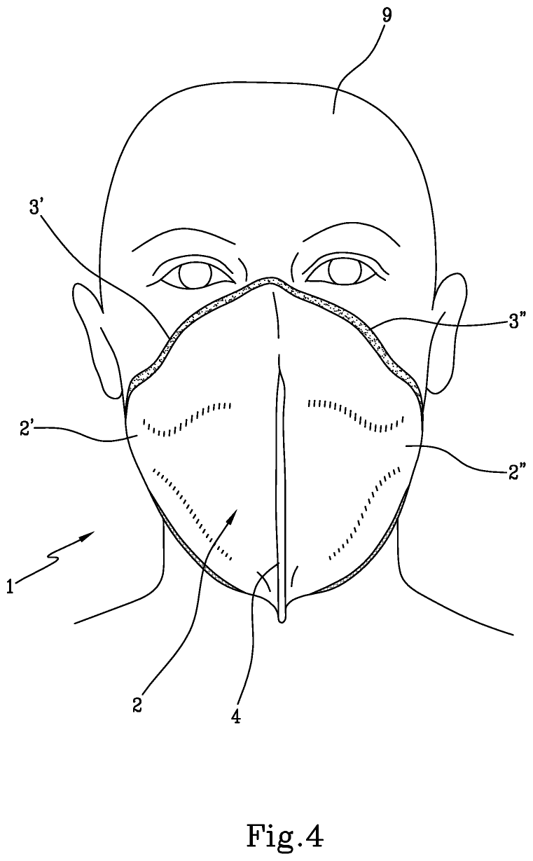

FIG. 4 shows a front view of the user 9 wearing the mask 1 of FIG. 1;

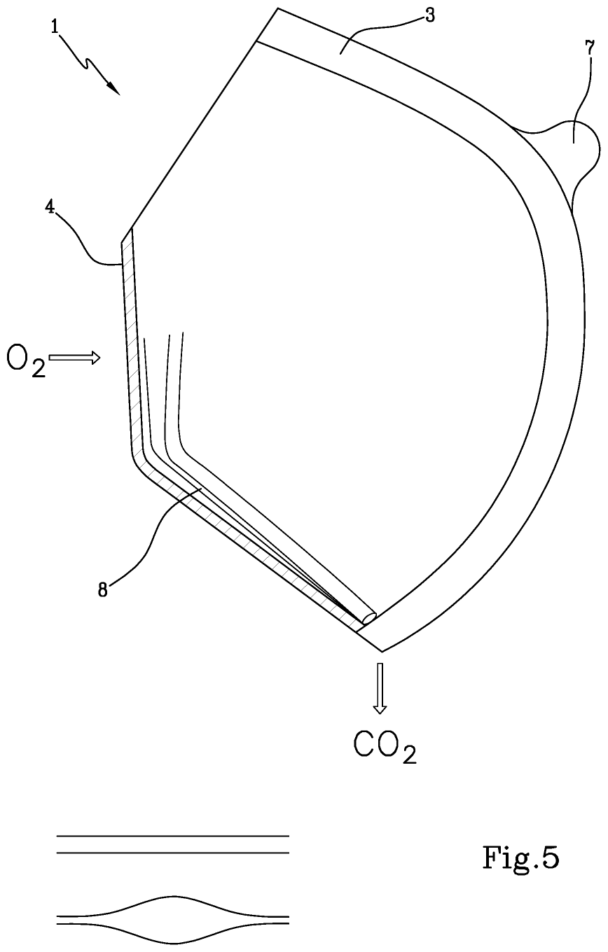

FIG. 5 schematically illustrates the operation of the opening 8 defined in the mask 1;

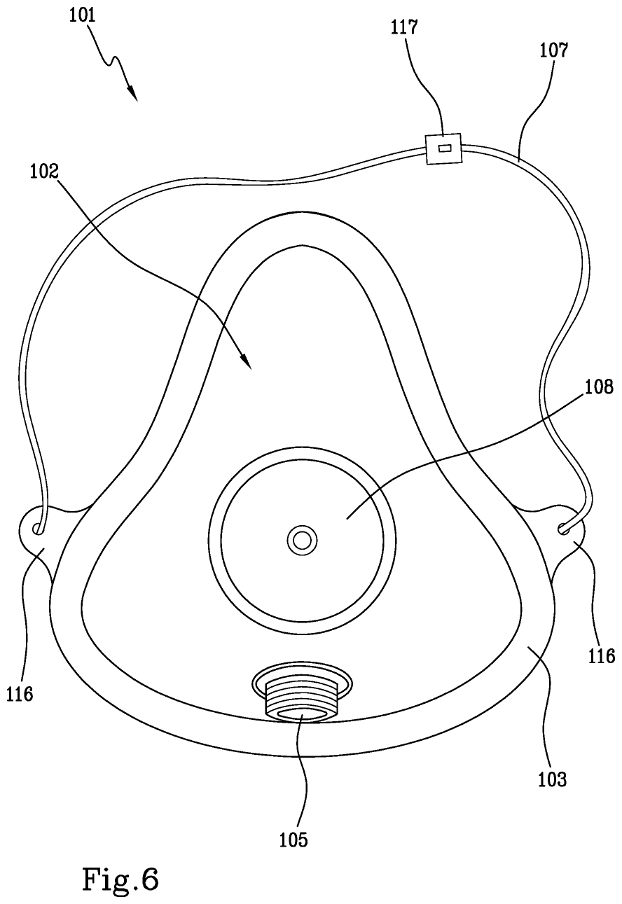

FIG. 6 shows a perspective view of the mask 101 with the semi-rigid covering portion 102;

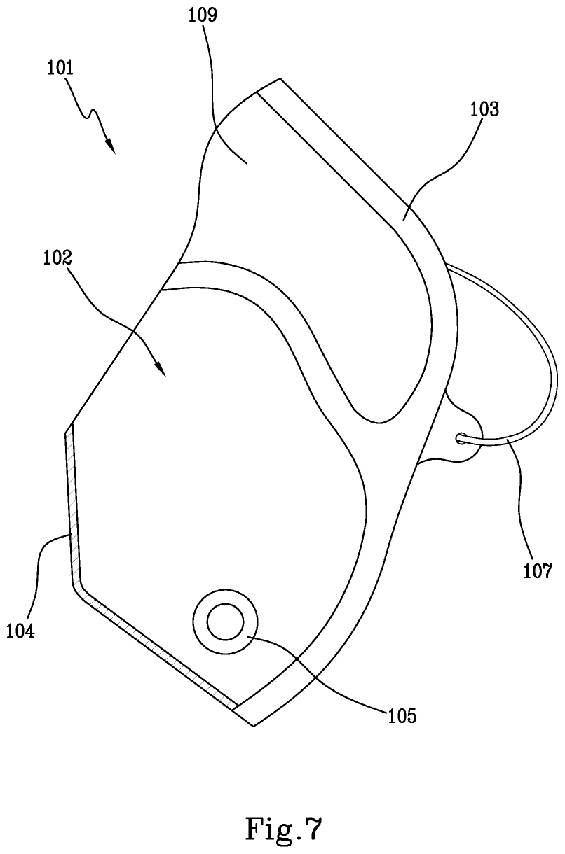

FIG. 7 shows a second version of the mask 101 with the covering portion 102 which covers the entire face, including the eye zone using the visor 109. The above-mentioned drawings show a preferred embodiment of a double-protection medical mask, preferably for filtering dust, smog, aerosol, pathogenic agents, viruses and the like, according to the invention, which is identified in its entirety with the numerals 1 and 101, which comprises a covering portion 2 and 102.

According to the first embodiment, the portion 2 of the mask 1 is made of fabric and is used to protect the zone of the nose, mouth and chin (FIGS. 1-5), whilst the portion 102 of the mask 101 of a variant embodiment is made of rigid or semi-rigid material and protects the entire face, except obviously the area of the eyes, which will be covered by other means which are not the object of the invention (FIG. 7).

The mask 1 of FIG. 1 also comprises a central border 4, of per se known type, extending substantially along the transversal axis of symmetry 10 of the covering portion 2.

In any case, the portion 2 (102) is designed to be hermetically and removably fixed to the face of the user 9 by adhesion means.

The covering portion 2 has bactericidal and virucidal substances inside it. These substances are silver ions, pure copper silver, or “Tea Tree Oil”, extract of grapefruit seeds, benzalkonium chloride, etc., inserted in the weft of the fabric.

According to a particular version of the invention, along the entire perimeter edge 3 there is a double peripheral edge with folds, that is to say, pleats, inserted between the outer surface of the covering portion 2 and the adhesion means.

According to a first variant embodiment, the adhesion means comprise a layer of medical glue, of per se known type, deposited along the perimeter edge 3 of the covering portion 2. This layer of glue is breathable and of a bactericidal type.

According to another variant, the adhesion means comprise a gel layer, for example made of gel, but also of made of hydrogel, but also of silicone material, rubber or other similar material, deposited along the perimeter edge 3 (103) of the covering portion 2 (102), which is designed to adhere on itself and to the face of the operator 9, allowing the adaptation to the shape of the face of the user 9. In this way, therefore, without the aid of glues the mask 1 (101) adheres perfectly to the face of the user 9.

The mask 1 (101) is therefore provided along its entire outer perimeter with an adhesive edge 3 (103) which is able to adapt to the face of any user 9.

Preferably, where the mask 1 (101) is equipped with ties or other means for connection to the head of the user 9, there are two outer flaps 7 which allow an easy gripping and facilitate setting up of the device 1 (101).

These flaps 7 may also be designed to house any ties or elastics for connection to the head of the user 9, of any type, by simply heat sealing or perforating the fabric of the mask 1 (101) for the passage of the tie.

The mask 1 (101) may be made of various materials, for example non-woven fabric, and may use specific adhesives such as Tegaderm® or silicone materials.

The mask 1 (101) is equipped with filter and water-repellent material, such as to also allow the use in damp environments and in occasional contact with water (professional or recreational use).

Preferably, the filter fabric is equipped with folds in such a way as to allow a greater filtering and respiratory capacity.

The perimeter edge 3 (103) comprises preservation means for the adhesive means, which are impermeable to water and air, for example by using a glue.

According to other variants, a watertight micro-hinge can be used or a hermetic closing mechanism made of plastic such as that used in bags with male-female edges or a mechanical closing system with Velcro or suction effect or magnetic means.

In any case, there is also, but not necessarily, the simultaneous presence of the two systems: adhesive on the inner part of the edge 3 (103) and mechanical closing on the outer part of the edge 3 (103).

For a professional use, each individual mask 1 or 101 is equipped with a “QR Code” which allows, by downloading a dedicated application (“app”) to the relative personal computer, smart phone, smartphone or tablet, information to be provided on the methods and time of use of the mask, the place of use, the quantity available for each operator, and to place orders for supplies when they fall below minimum threshold, etc.

In the lower part of the mask 1 made of filtering fabric or in any case non-rigid fabric, in the proximity of the jaw or under the chin, there is advantageously an opening 8 in the fabric, substantially parallel with the edge 3 of the mask designed to guarantee a “non-return valve” effect: the opening 8 is in fact able to automatically close during breathing in and open to favour breathing out. This effect, where provided because it is considered useful and safe, is simply achieved by cutting on one or more layers of filter fabric (FIG. 5).

With reference to FIGS. 2 and 4, the mask 1 (non-rigid) is designed to be folded into at least two parts, a right-hand part 2′ and a left-hand part 2″ relative to a transversal axis of symmetry 10 of the covering portion 2, in such a way that, once it has been folded, the right-hand part 2′ is hermetically and removably associated with the left-hand part 2″, thanks to the fact that the right-hand part 2′ has a right-hand portion of the perimeter edge 3 (right perimeter edge 3′) which is hermetically and removably associable with the left portion of the perimeter edge 3 (left perimeter edge 3″, which has the same features as the right edge 3′) defined on the left-hand part 2″ of the covering portion 2.

This is useful in the case of use of filtering masks 1 by patients with serious infections: this device, once removed from the patient's face, can be immediately and irreversibly sealed to prevent any dispersion of pathogenic agents in the surrounding environment simply by causing the perimeter edges 3 of the device removed to adhere to each other, or by acting on the mechanical closures.

Similarly, this is also useful for the healthy user who can reclose the mask and re-use it whilst maintaining the same degree of safety initially guaranteed by the mask 1.

Preferably, the mask has various colours and/or shapes and/or wording and/or signs which differentiate its use, distinguishing it between healthy and infected individuals.

In case of use by an infected person, it is necessary for the closure to be irreversible and, once closed, does not even allow the reopening, even occasionally.

According to the invention, in the case of excess, the perimeter edges 3 of the mask 1 are allowed to adhere to each other, adapting the profile of the mask to the morphology and the size of the face of the user 9 so as to keep intact the sealing capacity with solids and liquids.

This new feature makes the mask easy to wear, customisable to the user in a simple, but also effective and safe way for any user 9, men, women and children.

The covering portion 102 of a particular type of mask 101 is such as to cover the entire face of the user 9, except for the eyes.

By using a semi-rigid/rigid material, such as polycarbonate or the like, it is possible to make the containment shell in such a way as to perfectly cover both the mouth and the nose of the patient (FIG. 6).

With reference to FIG. 6, for this type of mask 101, the covering portion 102 is made of a rigid or semi-rigid material, equipped with suitable means for connection to the head of the user 9, for example ties 107 and preferably equipped with a regulator 117, housed on flaps 116 associated with the portion 102.

Suitable valves 105 and 108 advantageously provide for the filtering of the air and the safety.

For this reason, the mask 101 is extremely easy to wear and has an excellent sealing capacity which make it an excellent instrument for the so-called NIV therapy (“Non Invasive Ventilation”).

More specifically, in this case the ties 107 are advantageously useful because they are designed to support the seal of the adhesive edge 103 of the mask 101 in such a way as to oppose the thrust of the positive pressure deriving from the mechanical blowing means of the air.

The adhesion means guarantee the seal, whilst a simple tie passed behind the nape of the neck acts as a counter-thrust against the positive pressure exerted inside the device by the artificial respiratory device.

The mask 101 may, as mentioned above, be completed by a single inlet/outlet valve 105 (obviously two separate inlets can be provided), a safety valve 108 which opens in the case of an emergency and, if necessary, a cap to allow entry of oral treatments (administration of medicines, solutions, aerosols . . . ).

The patient will not have any feeling of oppression and will act with the maximum freedom of movement.

According to a further alternative, for an absolute protection of the mouth, nose and eyes, the mask 101 comprises a visor 109 which can be seen in FIG. 7. The visor 109, made of optically transparent material, guarantees maximum protection for the user even in the case of momentary immersion in liquids.

In practice, the user 9 who wants to wear the mask 1 must firstly pick it out from its sterile wrapper, open the two outer flaps 7 of the mask 1 and remove any protective film (not illustrated). Next, holding the mask 1 with the two flaps 7 well apart, it must be positioned on the nose and the fingers then slid along the two edges 3′ and 3″ of the mask 1 in such a way as to make the perimeter edge adhere to the face.

Therefore, as mentioned, any excess fabric edges will be sealed by making them adhere to each other, by means of the adhesion means, any excess parts of perimeter edges 3, for example in the zone below the chin, by reciprocal superposing in such a way that any excess parts of edges 3 which do not adhere to the face due to the morphology of the user 9, are sealed to each other simply by applying a slight pressure of the fingers of the user 9.

If re-use is necessary, the user 9 must simply remove the mask 1 from the face and fold it onto itself by causing all the perimeter edges 3 to adhere to each other; the mask 1 folded in this way will be placed in a case, in the pocket of trousers or gowns, in the case of medical operators, thus maintaining the relative previous safety parameters unchanged.

In this way, the inside of the mask 1 is hermetically sealed and protected against any form of contamination until its subsequent use, in absolute safety.

If the user 9 is infected by a virus, or other pathogens in such a way that he/she is dangerous and represents a potential source of contagion, once the new mask 1 has been worn he/she is immediately and completely isolated from the outside environment and is able to carry out all his/her actions with extreme freedom (without ties, elastics, constrictions, etc.) whilst wearing the mask 1.

If the mask 1 is worn, the patient 9 can also remove it by simply taking care to close the mask 1 on itself by making the perimeter edges 3″ which are superposed adhere to each other after folding, in such a way that all the exudated objects of potential contagion can remain hermetically sealed inside it. In this case, too, it is without doubt possible to re-use the new invention safely; obviously, the user 9 must be sufficiently informed about the methods of execution of the simple operations necessary in such a way as to act and ensure compliance with maximum safety criteria that the new invention is able to guarantee.

If the peripheral edge of the covering portion 2 has, on the other hand, the perimeter edges 3 equipped with a mechanical closing mechanism of the male/female type, the user, in order to close the mask 1, must consequently press the edges 3 together.

If the peripheral edge has a full barrier hinge in the perimeter edges 3, this hinge must be reclosed.

In this way, the safety chain is guaranteed before, during and after use, from the moment it is applied up to the destruction centre, without there being inhaling or loses which could contaminate the rooms and the workers responsible for collection.

Moreover, the bactericidal agents used during the production phase and still present in the mask 1 continue their action to attack the pathogens even when the mask 1 is disposed of. Similarly, before closing the mask, it may be subjected to nebulising with alcohol or other disinfectant, in such a way as to definitively neutralise any pathogen present inside it.

From the above description it may be seen how the invention achieves the preset purpose and aims and in particular the fact that a double-protective medical mask is made, preferably for the filtering dust, smog, aerosol, pathogenic agents, viruses, including SARS, COVID and the like, which avoids any problems connected with the facial seal and allows a mask to be made which guarantees the perfect seal for any facial morphology of the user, whether it is a man, with or without a beard (having the main fastening point along the entire nose and above the mouth), a women, or a child: the presence of the perimeter edge of integral adhesion makes the system adaptable to any face and guarantees a perfect seal.

In particular, the presence of adhesion edges which have an excellent seal and can be re-used allows efficiency and protection for the user who needs to temporarily remove the mask and then put it back.

Another advantage of the invention is that the mask described above is the guarantee of a perfect seal which definitively solves the problem of misting up of spectacles; this problem must not be underestimated as it makes the work of professionals difficult and adversely affects it. This increases the safety and comfort for health personnel, as well as improving use by normal users.

Another advantage of the double-protective medical mask is due to the fact that the mask is equipped with an active and passive double-protection system which improves the effectiveness of the masks on the market and even allows immersion under water.

Lastly, another advantage of the invention is due to the fact that, despite the absolute guarantee of safety, the new device is characterised in that it has a low production cost even in terms of engineering of the machines necessary for production, allowing on the one hand, for it to be economically competitive, and, on the other hand, to provide a product which is original, exclusive and with high margins.

The invention can be modified and adapted in several ways without thereby departing from the scope of the inventive concept.

Moreover, all the details of the invention may be substituted by other technically equivalent elements.

In practice, the materials used, as well as the dimensions, may be of any type, depending on requirements, provided that they are consistent with their production purposes.

1. A double-protection medical mask (1, 101), preferably for filtering dust, smog, aerosol, pathogenic agents, viruses and the like, comprising a portion (2, 102) covering at least of the area of the nose, mouth and chin, provided with filtration means and designed to be hermetically and removably fixed to the face of the user (9) by adhesion means.

2. The mask (1, 101) according to claim 1, wherein said covering portion (2, 102) comprises at least one folded peripheral edge, with an accordion effect, inserted along at least part of the perimeter edge (3, 103) of said covering portion (2), between the outer surface of said covering portion (2, 102) and said adhesion means.

3. The mask (1, 101) according to claim 1, wherein said adhesion means comprise a layer of medical adhesive deposited along the perimeter edge (3, 103) of said covering portion (2, 102), preferably said layer of medical adhesive being breathable and/or of the bactericidal type.

4. The mask (1, 101) according to claim 3, wherein said adhesion means comprise a gel layer, deposited along the perimeter edge (3, 103) of said covering portion (2, 102), said gel layer being designed to removably adhere both on itself and on the face of the user (9), in such a way as to adapt said perimeter edge (3, 103) to the shape of the face of the user (9).

5. The mask (1, 101) according to claim 1, wherein said covering portion (2, 102) comprises bactericidal means applied to its inner surface.

6. The mask (1, 101) according to claim 1, wherein said covering portion (2, 102) comprises means for controlling the regular use of the mask (1, 101), said control means being designed to be applied to the inner and/or outer surface of said covering portion (2, 102).

7. The mask (1, 101) according to claim 1, wherein said adhesive edge (3, 103) comprises preservation means.

8. The mask (1, 101) according to claim 7, wherein said preservation means comprise bonding means or a sealed micro-hinge or a hermetic closing mechanism with a male-female edge or a mechanical closing system with Velcro or a mechanical closing system with a suction effect or magnetic means.

9. The mask (1, 101) according to claim 1, having a two-dimensional bar code comprising at least one data storage cryptogram designed to be read using optical means connected to a processing unit, in such a way as to access a data processor program, said data regarding the methods and the time of use of the mask (1, 101) and/or the place of use of the mask and/or the quantity available for each user (9) and/or to send a re-assignment order when it falls below a predetermined minimum threshold.

10. The mask (1) according to claim 4, made with water-repellent and breathable fabric.

11. The mask (1) according to claim 10, wherein said adhesive edge (3, 103) comprises preservation means, and wherein said preservation means comprise bonding means or a sealed micro-hinge or a hermetic closing mechanism with a male-female edge or a mechanical closing system with Velcro or a mechanical closing system with a suction effect or magnetic means, and wherein the preservation means are designed to allow the partial closing of the mask on itself in such a way that any excess of those parts of said adhesive edge (3) which do not adhere to the face of the user (9) are removably associated with each other allowing the customised adjustment of the mask (1).

12. The mask (1) according to claim 1, designed to be folded into at least two parts, a right-hand part (2′) and a left-hand part (2″) relative to a transversal axis of symmetry (10) of said covering portion (2), in such a way that, once said mask (1, 101) has been folded, said right-hand part (2′) has a right-hand perimeter edge (3′) hermetically and removably associated with a left-hand perimeter edge (3″) formed on said left-hand part (2″), in such a way as to protect the inner chamber of the mask (1) from outer contamination.

13. The mask (101) according to claim 4, wherein said covering portion (102) is designed to cover the face of the user (9) and is made of rigid or semi-rigid material and comprises means (107) for connection to the head of the user (9) designed to support the seal of the adhesive edge (103) for opposing the thrust of the positive pressure deriving from air blowing means.
